(19) United States
(12) Patent Application Publication
(10) Pub. No.: US 2023/0304195 A1
(43) Pub. Date: Sep. 28, 2023

(54) STRETCH BROKEN FIBER MATERIALS AND METHODS OF FABRICATION THEREOF

(71) Applicant: MONTANA STATE UNIVERSITY, Bozeman, MT (US)

(72) Inventors: Eric J. BOOTH, Bozeman, MT (US); Douglas S. CAIRNS, Bozeman, MT (US)

(21) Appl. No.: 18/042,188

(22) PCT Filed: Aug. 23, 2021
(86) PCT No.: PCT/US2021/047123

§ 371 Date: Feb. 17, 2023

Related U.S. Application Data
(60) Provisional application No. 63/123,248, filed on Dec. 9, 2020.
(60) Provisional application No. 63/070,151, filed on Aug. 25, 2020.

(51) Int. Cl. D01G 1/08

(52) U.S. Cl. CPC D01G 1/08; D10B 2101/12

(57) ABSTRACT

A method and system for producing stretch-broken fiber material includes feeding a fiber material including a plurality of continuous filaments and a continuous carrier film into a stretch breaking apparatus such that the continuous carrier film contacts the fiber material, and breaking at least a portion of the plurality of continuous filaments of the fiber material using the stretch breaking apparatus while the continuous carrier film contacts the fiber material to produce a stretch broken fiber material contacting the continuous carrier film.

### RELATED APPLICATIONS

This application claims the benefit of priority to U.S. Provisional Application No. 63/070,151, entitled “Technique, Method and Device for the Manufacture of Stretch Broken Carbon Fiber,” filed on Aug. 25, 2020, and claims the benefit of priority to U.S. Provisional Application No. 63/123,248, entitled “Technique, Method and Device for the Manufacture of Stretch Broken Carbon Fiber,” filed on Dec. 10, 2020, the entire teachings of both of which are incorporated by reference herein for all purposes.

### GOVERNMENT SUPPORT

This invention was made with Government support under Contract No. W911W6-18-C-0050 awarded by the U.S. Department of the Army (USARO). The Government has certain rights in the invention.

### FIELD

The present disclosure relates generally to stretch broken fiber material, and in particular stretch broken carbon fiber material, and methods of fabricating such material using one or more carrier films.

### BACKGROUND

Composite materials, such as carbon fiber materials, are used in a wide variety of applications. One type of composite material that has shown increased promise is stretch broken carbon fiber (SBCF) material, which is formed by modifying the properties of traditionally-prepared carbon fiber filaments using mechanical stretching. The stretching process cleaves the fibers at their natural weak points and effectively shortens the length of the fibers. This may enhance the resulting carbon fiber material in a number of ways, including improving the manufacturability of carbon fiber parts due to the macroscopic “ductile” behavior of the SBCF material. This may enable the manufacture of more intricate parts and complex geometries using SBCF materials. The stretch breaking process may also remove natural flaws from the carbon fiber material, which can improve material strength, and may also help reduce the costs of finished carbon fiber parts and structures by enabling less expensive manufacturing processes.

One current technique for fabricating SBCF materials includes employing a series of rollers, driven at different rotation speeds, to elongate and selectively cleave the carbon fibers. However, there are a number of limitations of this technique as currently implemented, including inadequate fiber shortening, a variety of scale-up difficulties, and difficulties in handling the shortened fibers after they have been broken. In particular, the unsupported carbon fiber tow, once it is stretch broken, is difficult to handle. In addition, breakage of the carbon tow, fibers wrapping around the rollers, debris adhesions on the rollers, and a host of other scale-up difficulties have been routinely encountered. Many of these problems require the stretch breaking machine to be stopped, cleaned, and reset before the SBCF manufacturing can restart. As a result, the commercial adoption of this technique has been limited to date.

### SUMMARY

According to an embodiment of the present disclosure, a method of producing stretch-broken fiber material includes feeding a fiber material including a plurality of continuous filaments and a continuous carrier film into a stretch breaking apparatus such that the continuous carrier film contacts the fiber material, and breaking at least a portion of the plurality of continuous filaments of the fiber material using the stretch breaking apparatus while the continuous carrier film contacts the fiber material to produce a stretch broken fiber material contacting the continuous carrier film.

An additional embodiment includes a system for producing stretch broken fiber material that includes a stretch breaking apparatus configured to break filaments of a fiber material to reduce a mean filament length of the fiber material, a feed apparatus configured to feed a continuous carrier sheet into the stretch breaking apparatus such that the continuous carrier sheet contacts the fiber material while the stretch breaking apparatus breaks filaments of the fiber material.

An additional embodiment includes a stretch-broken carbon fiber material that is formable using a forming force that is 1 MPa or less.

An additional embodiment includes a dry stretch-broken carbon fiber product including a tow of stretch-broken carbon fibers wherein ≥98% of the fibers of the tow of stretch-broken carbon fibers are aligned within 2°.

Various embodiments of the present disclosure may overcome limitations of the current stretch broken fiber manufacturing processes described above by utilizing one or more carrier film(s), such as a polymeric carrier film, as an integral component in the stretch breaking process. The carrier film(s) may be employed on one side or both sides of a fiber material bundle during the stretch breaking process. In various embodiments, the use of a carrier film may improve the grip on the fibers, may prevent the fibers from sticking to the stretch breaking machinery, and may provide a backing that allows subsequent improved handling of the formable material produced in the stretch breaking process. Use of a carrier film may also provide shorter fiber lengths that may significantly improve the SBCF formability and strength.

### BRIEF DESCRIPTION OF THE DRAWINGS

FIG. 1 schematically illustrates a differential roller system for producing stretch broken fiber material according to embodiments of the present disclosure.

FIG. 2 schematically illustrates a dual platen system for producing stretch broken fiber material according to embodiments of the present disclosure.

FIG. 3A is a top view of a stretch broken fiber material on a carrier film.

FIG. 3B is a cross-section view of the stretch broken fiber material and the carrier film along line A-A′ in FIG. 3A.

FIG. 3C is a cross-section view of a stretch broken fiber material sandwiched between a first carrier film and a second carrier film.

FIG. 3D is a top view illustrating two tows of stretch broken fiber material on a carrier film.

FIG. 4 is a plot of the fiber length profile of an embodiment stretch broken carbon fiber (SBCF) material produced using a carrier film contacting the carbon fiber material during the stretch breaking process and the fiber length profiles of three comparative examples of SBCF materials that were produced using a conventional technique.

FIG. 5 shows micrographs of SBCF materials, including (A) a comparative example of an SBCF material that was produced using a conventional technique that did not include a carrier film contacting the fiber material during the stretch breaking process, and (B) an embodiment SBCF material that was produced using a carrier film contacting the carbon fiber material during the stretch breaking process.

FIG. 6 schematically illustrates a differential roller system for producing prepreg stretch broken fiber material that includes a feed apparatus configured to feed a resin-containing sheet into the stretch breaking apparatus to contact a stretch broken fiber material.

FIG. 7 is a plot illustrating the formability of an embodiment SBCF material that was produced using a carrier film contacting the carbon fiber material during the stretch breaking process in comparison to the formability of a comparative example of an SBCF material that was produced using a conventional technique.

FIG. 8A is a top view showing a carrier film including a plurality of perforations.

FIG. 8B is a cross-section view of a fiber material located between two perforated carrier films.

FIG. 9 schematically illustrates a differential roller system for producing stretch broken fiber material that includes a feed apparatus configured to feed a stiffening sheet into the stretch breaking apparatus to contact a surface of a carrier film.

FIG. 10 is a flow diagram illustrating a method of producing stretch broken fiber material according to various embodiments of the present disclosure.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The present invention can “comprise” (open ended) or “consist essentially of” the components of the present invention as well as other ingredients or elements described herein. As used herein, “comprising” means the elements recited, or their equivalent in structure or function, plus any other element or elements which are not recited. The terms “having” and “including” are also to be construed as open ended unless the context suggests otherwise. As used herein, “consisting essentially of” means that the invention may include ingredients in addition to those recited in the description and/or claim, but only if the additional ingredients do not materially alter the basic and novel characteristics of the claimed invention.

Any and all ranges recited herein include the endpoints, including those that recite a range “between” two values. Terms such as “about,” “generally,” “substantially,” “approximately” and the like are to be construed as modifying a term or value such that it is not an absolute, but does not read on the prior art. Such terms will be defined by the circumstances and the terms that they modify as those terms are understood by those of skill in the art. This includes, at very least, the degree of expected experimental error, technique error and instrument error for a given technique used to measure a value. Unless otherwise indicated, as used herein, “a” and “an” include the plural, such that, e.g., “a medium” can mean at least one medium, as well as a plurality of mediums, i.e., more than one medium.

Where used herein, the term “and/or” when used in a list of two or more items means that any one of the listed characteristics can be present, or any combination of two or more of the listed characteristics can be present. For example, if a composition of the instant invention is described as containing characteristics A, B, and/or C, the composition can contain A feature alone; B alone; C alone; A and B in combination; A and C in combination; B and C in combination; or A, B, and C in combination.

Various embodiments of the present disclosure relate to methods and systems for producing stretch-broken fiber material, such as stretch-broken carbon fiber materials. In accordance with various embodiments of the present disclosure, at least one continuous carrier film may be fed into a stretch breaking apparatus such that the at least one continuous carrier film contacts the fiber material as filaments of the fiber material are broken using the stretch breaking apparatus. The at least one carrier film may stretch but not break during the stretch breaking process such that the stretch broken fiber material may contact at least one continuous carrier film.

In various embodiments, providing a continuous carrier film contacting the fiber material during the stretch breaking process may help to maintain organization and alignment of the stretch-broken fiber filaments, which may allow for improved handling and transport of the stretch-broken fiber material, as well as improved properties of the finished parts that may be manufactured using the stretch-broken fiber material. The use of at least one carrier film may also provide a barrier between the fiber material and components of the stretch breaking apparatus, which may minimize wear and debris on the stretch breaking apparatus, and may improve the reliability and efficiency of the stretch broken fiber manufacturing process.

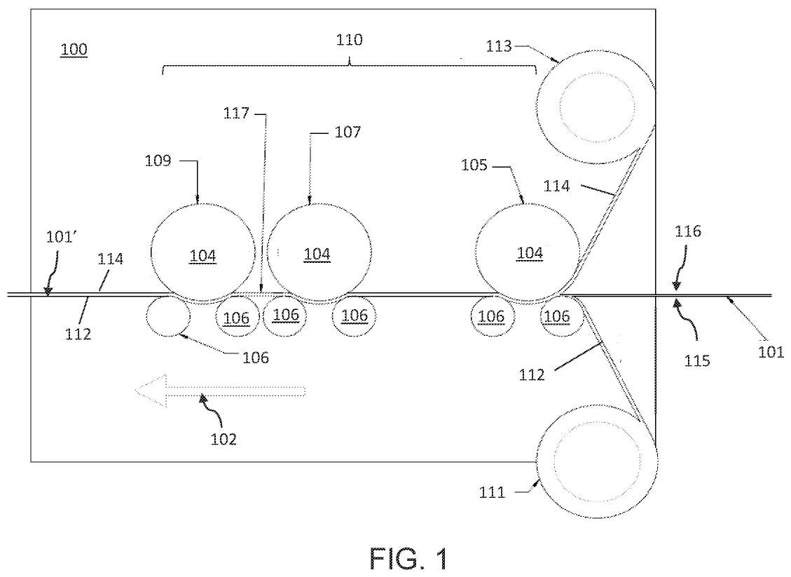

FIG. 1 is a schematic illustration of a differential roller system 100 for producing stretch broken fiber material according to various embodiments of the present disclosure. A fiber material 101 composed of a plurality of continuous fiber filaments may be fed into a stretch breaking apparatus 110 and may be placed under tension by a plurality of rollers 104, 106 of the stretch breaking apparatus 110. In the embodiment shown in FIG. 1, the stretch breaking apparatus 110 includes three sets of rollers 105, 107 and 109 (which may also be referred to as first, second and third nip stations 105, 107 and 109, respectively). The fiber material 101 may proceed through each of the first, second and third nip stations 105, 107 and 109 along the direction of arrow 102. At each nip station 105, 107 and 109, the fiber material 101 may pass between a first roller 104 and at least one second roller 106. In the embodiment shown in FIG. 1, each nip station 105, 107, 109 includes a first roller 104 and a pair of second rollers 106 having a smaller diameter than the first roller 104. At least one roller 104, 106 in each nip station 105, 107 and 109 may be a drive roller that may be controlled to rotate at a pre-determined speed. The remaining rollers 104, 107 in each nip station 105, 107 and 109 may optionally be idler rollers. In embodiments, the first rollers 104 may have an outer surface composed of a durable material, such as urethane. In some embodiments, the second rollers 106 may have an outer surface composed of a metal or metal alloy, such as a steel material.

The system 100 may also include at least one feed apparatus 111, 113 configured to feed a carrier film 112, 114 into the stretch breaking apparatus 110. In the embodiment of FIG. 1, a first feed apparatus 111 may include a first spool that may feed a first carrier film 112 into the first nip station 105 of the stretch breaking apparatus 110. A second feed apparatus 113 may include a second spool 113 that may feed a second carrier film 114 into the first nip station 105 of the stretch breaking apparatus 110. The first carrier film 112 may be fed through each of the nip stations 105, 107 and 109 of the stretch braking apparatus 110 such that the first carrier film 112 is located between a first side 115 of the fiber material 101 and each of the second rollers 106 of the respective nip stations 105, 107 and 109. The second carrier film 114 may be fed through each of the nip stations 105, 107 and 109 of the stretch braking apparatus 110 such that the second carrier film 114 is located between a second side 116 of the fiber material 101 and each of the first rollers 104 of the respective nip stations 105, 107 and 109. Although the embodiment of FIG. 1 shows first and second carrier films 112, 114 located on opposite sides 115, 116 of the fiber material 101, it will be understood that in some embodiments, a carrier film the first carrier film 112 or the second carrier film 114) may only be located on a single side of the fiber material 101 as the fiber material 101 progresses through the first, second and third nip stations 105, 107 and 109.

The rollers 104, 106 of the respective nip stations 105, 107, 109 may be driven to rotate at different speeds, which may impart tension on the fiber material 101, the first carrier film 112, and the second carrier film 114 as they are fed through the stretch breaking apparatus 110. In various embodiments, the rollers 104, 106 of the third nip station 109 may rotate at a higher speed than the rollers 104, 106 of the second nip station 107. This may impart a tension on the fiber material 101, the first carrier film 112 and the second carrier film 114 in the region 117 between nip station 107 and nip station 109 (which may also be referred to as a “break zone”). The tensile strain on the fiber material 101 within the break zone 117 may be sufficient to cause at least a portion of the filaments of the fiber material 101 to cleave along weak points of the filaments, thereby reducing a mean length of the filaments and producing a stretch broken fiber material 101′. However, the tensile strain on the first carrier film 112 and the second carrier film 114 within the break zone 117 may cause the films 112 and/or 114 to elongate (i.e., stretch), but may not be sufficient to cause the carrier films 112 and/or 114 to break.

Accordingly, as the stretch broken fiber material 101′ exits the stretch breaking apparatus 110, the stretch broken fiber material 101′ may contact a continuous first carrier film 112 and/or a continuous second carrier film 114. In some embodiments, the stretch broken fiber material 101′ may be sandwiched between a continuous first carrier film 112 and a continuous second carrier film 114. In various embodiments, the carrier film(s) 112 and/or 114 may help to maintain organization and alignment of the stretch-broken fiber filaments, which may allow for improved handling and transport of the stretch-broken fiber material 101′, as well as improved properties of the finished parts that may be manufactured using the stretch-broken fiber material 101′. The first carrier film 112 and the second carrier film 114 may also provide a barrier between the fiber material 101 and the rollers 104, 106 of the stretch breaking apparatus 110, which may prevent fibers from adhering to or wrapping around the rollers 104, 106, and may also help protect the stretch breaking apparatus 110 from debris. In addition, the wear on the rollers 104, 106 may be significantly decreased, since direct contact between the rollers 104, 106 and abrasive fiber material may be reduced or eliminated. This may reduce down-time and increase the service life of the stretch breaking apparatus 110, and may improve the overall reliability and cost-effectiveness of the stretch-broken fiber manufacturing process.

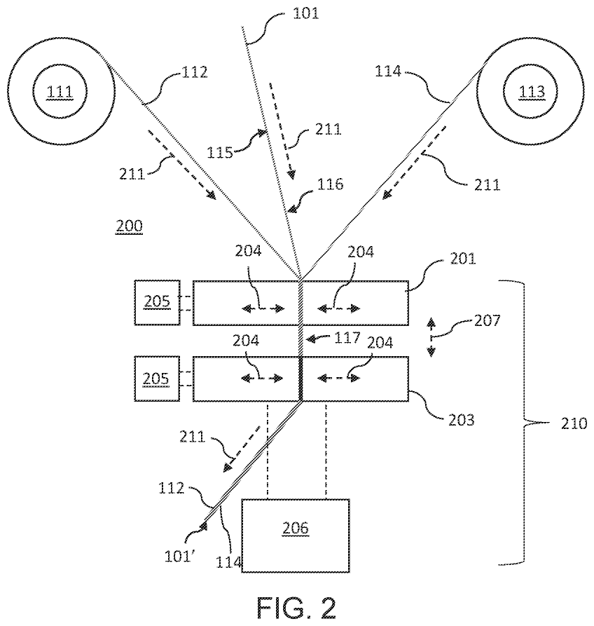

FIG. 2 schematically illustrates an alternative system 200 for producing stretch-broken fiber material 101′. The system 200 shown in FIG. 2 includes a dual-platen stretch breaking apparatus 210. As in the system 100 shown in FIG. 1, a fiber material 101 may be fed into the dual platen stretch breaking apparatus 210. The system 200 may also include at least one feed apparatus 111, 113 configured to feed a carrier film 112, 114 into the stretch breaking apparatus 210. In the embodiment of FIG. 2, a first feed apparatus 111 may include a first spool that may feed a first carder film 112 into the dual platen stretch breaking apparatus 210 such that the first carrier film 112 is located on a first side surface 115 of the fiber material 101. A second feed apparatus 113 may include a second spool that may feed a second carrier film 114 into the dual platen stretch breaking apparatus 210 such that the second carrier film 112 is located on a second side surface 116 of the fiber material 101. Although the embodiment shown in FIG. 2 illustrates a pair of carrier films 112 and 114 contacting two opposing sides 115 and 116 of the fiber material 101, it will be understood that in some embodiments, the fiber material 101 may only be contacted by a single carrier film 112 or 114.

The fiber material 101 and the at least one carrier film 112 and/or 114 may proceed through a pair of platen systems 201 and 203 of the dual platen stretch breaking apparatus 210, where each of the platen systems 201 and 203 may be operatively coupled to an actuator system 205 that may selectively apply a pressure to the fiber material 101 and the carrier film(s) 112, 114 along the direction of arrows 204. A second actuator system 206 may be configured to selectively move the platen systems 201 and 203 relative to one another along the direction of arrow 207. In operation, as the fiber material 101 and the at least one carrier film 112 and/or 114 are fed through the dual platen stretch breaking apparatus 210 along the direction of arrows 211, the platen systems 201 and 203 may selectively grip the sides of the fiber material 101 and the carrier film(s) 112, 114 while the second actuator system 206 may move the platen systems 201 and 203 away from one another along the direction of arrow 207. This may elongate the fiber material 101 and the at least one carrier film 112 and/or 114 within a break zone 117 located between the respective platen systems 201 and 203. The tensile strain on the fiber material 101 within the break zone 117 may be sufficient to cause at least a portion of the filaments of the fiber material 101 to cleave along weak points of the filaments, thereby reducing a mean length of the filaments and producing a stretch broken fiber material 101′. However, the tensile strain on the first carrier film 112 and the second carrier film 114 within the break zone 117 may cause the at least one carrier film 112 and/or 114 to elongate (i.e., stretch), but may not be sufficient to cause the carrier films 112 and/or 114 to break.

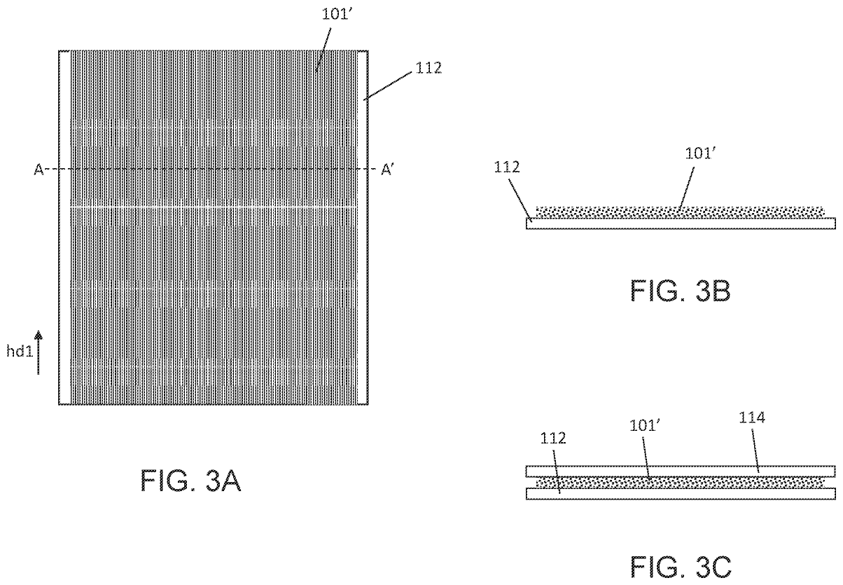

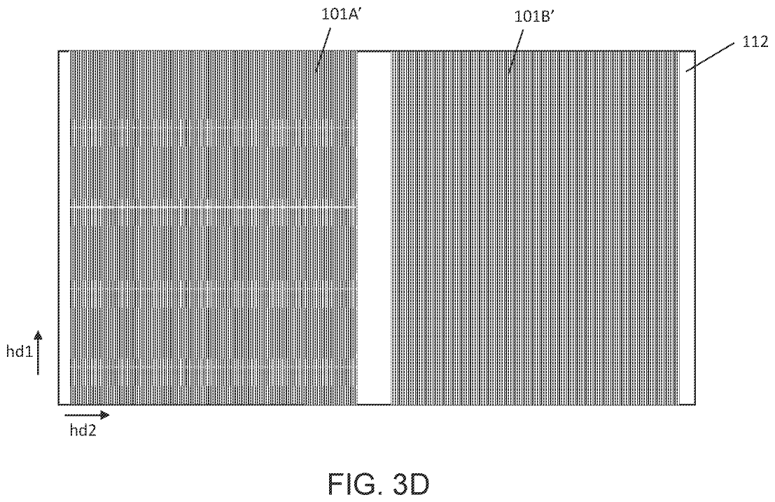

FIG. 3A is a top view of a stretch broken fiber material 101′ on a carrier film 112 and FIG. 3B is a cross-section view of the stretch broken fiber material 101′ and the carrier film 112 along line A-A′ in FIG. 3A. The stretch broken fiber material 101′ may be produced using a suitable process, such as a differential roller-based stretch breaking process as described above with reference to FIG. 1, or a dual platen-based stretch breaking process as described above with reference to FIG. 2. Other suitable methods for producing the stretch broken fiber material 101′ are within the contemplated scope of disclosure, including, for example, the use of breaker bars to cleave the fiber filaments. The stretch broken fiber material 101′ may be supported on the carrier film 112, which may help to maintain alignment of the stretch broken filaments along a first horizontal direction (hd1) and may promote ease of handling of the stretch broken fiber material 101′. In some embodiments, the stretch broken fiber material 101′ may be sandwiched between a first carrier film 112 and a second carrier film 114, as shown in the cross-section view of FIG. 3C.

In various embodiments, the stretch broken fiber material 101′ may be located on a carrier film 112, or may be located between two carrier films 112 and 114, during the stretch breaking process used to produce the stretch broken fiber material 101′. The stretch breaking process may cleave filaments of the fiber material in one or more locations along the first horizontal direction (hd1) to reduce the mean length of the filaments. As discussed above with reference to FIGS. 1 and 2, the stretch breaking process may result in the carrier film(s) 112, 114 becoming stretched, but not broken, so that following the stretch breaking process, the carrier film(s) 112, 114 may extend continuously along the first horizontal direction (hd1).

In some embodiments, multiple bundles of fibers (which may also be referred to as “tows”) may be processed simultaneously by a stretch breaking apparatus, such as a differential roller stretch breaking apparatus 110 as shown in FIG. 1. The multiple tows of fiber material 101 may proceed side-by-side through the stretch breaking apparatus 110 while each of the tows of fiber material 101 contacts at least one carrier film 112, 114 as described above. In some embodiments, each tow may contact a different carrier film, or each tow may be sandwiched between different pairs of carrier films. Alternatively, multiple tows may contact the same carrier film 112 and/or 114. FIG. 3D is a top view illustrating two tows of stretch broken fiber material 101A′ and 101B′ on a carrier film 112. Each of the tows of stretch broken fiber material 101A and 101B may contact the same carrier film 112 as the fiber material is fed through a stretch breaking apparatus 110 along the first horizontal direction (hd1) to produce stretch broken fiber material 101A′ and 101B′. The individual tows of stretch broken fiber material 101A and 101B may be laterally spaced along a second horizontal direction (hd2). In some embodiments, an additional carrier film (not shown in FIG. 3D) may contact the respective tows of fiber material 101A and 101B on the upper surfaces of the fiber material 101A and 101B.

The stretch broken fiber material 101′ according to various embodiments of the present disclosure may be a carbon fiber material, although other suitable fiber materials are also within the contemplated scope of disclosure. For example, the stretch broken fiber material 101′ may include fiberglass, an organic fiber material, such as KEVLAR® fiber material, ceramic fibers, glass fibers, basalt fibers, graphite fibers, and other fiber materials characterized by a relatively high strength and stiffness. In one embodiment, the stretch broken fiber material 101′ may be composed of a fiber material having a Young's modulus between 5 Mpsi and 120 Mpsi.

The carrier film(s) 112, 114 according to various embodiments of the present disclosure may be composed of a polymer material, such as a linear low-density polyethylene (LLDPE) material, although other suitable materials for the carrier film(s) 112, 114 are within the contemplated scope of disclosure. For example, the carrier film(s) 112, 114 may be composed of one or more of a polymer material, a rubber material, a thermoplastic material (e.g., polyimide, polypropylene, polyether ether keytone (PEEK), polyamide, etc.), a textile material, a woven material, and/or a paper-based material. In some embodiments, a surface of at least one carrier film 112, 114 that contacts the fiber material may include an adhesive material, such as an epoxy resin, which may promote contact between the carrier film 112, 114 and the fiber material and may also help to maintain alignment of the fiber material following the stretch breaking process.

In various embodiments, the carrier film(s) 112, 114 may be composed of material(s) having a higher degree of stretchability before they break as compared to the fiber material 101. For example, a carbon fiber filament under a tensile stress will typically elongate (i.e., stretch) by about 2% of its length before breaking. In various embodiments, the carrier film 112 and/or 114 that contacts the fiber material 101 may elongate (i.e., stretch) under a tensile stress by at least 6% of its length, including at least 10% of its length, such as between 15-20% of its length, before breaking.

In some embodiments, the carrier film(s) 112, 114 may be removed from the stretch broken fiber material 101′ prior to forming the broken fiber material 101′ into a manufactured part. In embodiments, the carrier film(s) 112, 114 that are removed from the stretch broken fiber material 101′ may be composed of recyclable materials. In some embodiments, the entire carrier film(s) 112, 114 may optionally be reused in a subsequent stretch breaking process to produce additional stretch broken fiber material 101′.

In some embodiments, at least one of the first carrier film 112 and/or the second carrier film 114 may remain in contact with the stretch broken fiber material 101′ during the process in which the stretch broken fiber material 101′ contacting the carrier film 112, 114 is formed into a manufactured part. For example, the carrier film 112 and/or 114 may remain in contact with the stretch broken fiber material 101′ in cases in which one or more properties of the carrier film 112, 114 may be beneficial to the end-product part that is manufactured using the stretch broken fiber material 101′. In one non-limiting example, a carrier film 112, 114 that includes a thermoplastic material or matrix may enable the thermoplastic material or matrix to become engrained or impregnated with the stretch broken fiber material 101′. In some embodiments, the engrained or impregnated thermoplastic material may provide faster curing and/or cycling times, as well as other improved properties to the finished manufactured part. In some embodiments, the carrier film 112, 114 may include a material, such as an epoxy resin, that enables the stretch broken fiber material 101′ contacting the carrier film 112, 114 to sink into the carrier film 112, 114 when the carrier film 112, 114 is heated in order to produce a matrix that includes the carrier film material(s) ingrained with the stretch broken fibers.

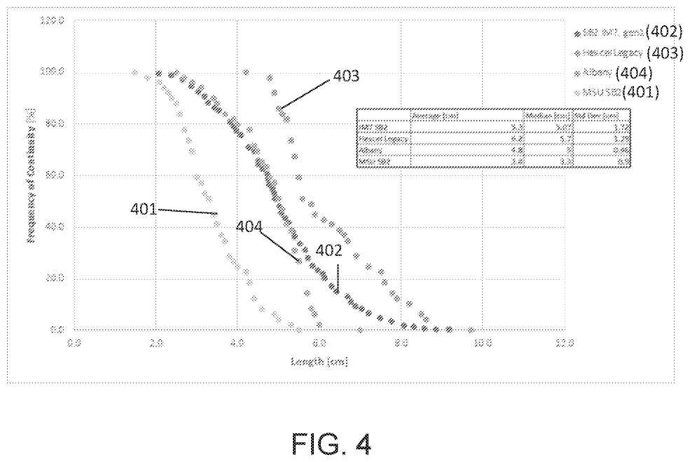

Stretch broken fiber material 101′, such as stretch broken carbon fiber (SBCF), may be composed of fibers of various lengths. Differences in the fiber lengths of the stretch broken fiber material 101′ may provide materials having differing behaviors and properties. A measurement of the individual fiber lengths within a bundle or tow of stretch broken fiber material may be made and the resulting distribution of fiber lengths may be indicative of the material's properties. FIG. 4 is a plot of the fiber length profile 401 of an embodiment stretch broken carbon fiber (SBCF) material (MSU SB2) that was produced using a carrier film contacting the carbon fiber material during the stretch breaking process, as described above, and the fiber length profiles 402, 403, 404 of three comparative examples of stretch broken carbon fiber (SBCF) materials (i.e., IM7 SB2, Hexcel Legacy, and Albany) that were produced using a conventional technique that did not include a carrier film contacting the fiber material during the stretch breaking process. As can be seen in FIG. 4, the fiber length profile 401 of the embodiment SBCF material shows a significant reduction in mean fiber length (i.e., 3.4 cm) as compared to the mean fiber lengths of the comparative examples 402, 403 and 404 (i.e., 5.3 cm, 6.2 cm and 4.8 cm, respectively). The embodiment SBCF material 401 made with the carrier film also exhibits a much tighter distribution of fiber lengths and shows a reduction in long fibers as compared to the comparative examples 402, 403 and 404. The reduction or elimination of long fibers in SBCF material, such as fibers having a length greater than 6 cm, may help to provide a macroscopically formable carbon fiber material.

In various embodiments, a SBCF material produced using a carrier film contacting the carbon fiber material during the stretch breaking process may have a mean fiber length of less than 4 cm. In some embodiments, the SBCF material produced using a carrier film contacting the carbon fiber material during the stretch breaking process may have a median fiber length of less than 5 cm, such as less than 4 cm. In some embodiments, a standard deviation of the fiber lengths of the embodiment SBCF material may be less than 0.95. In some embodiments, less than 0.01% of the fibers of the embodiment SBCF material may have a fiber length that is greater than 6 cm. In some embodiments, more than 50% of the fibers of the embodiment SBCF material may have a fiber length that is between 1.0 cm and 3.5 cm. In some embodiments, more than 2% of the fibers of the embodiment SBCF material may have a fiber length that is less than 2 cm. In some embodiments, the fiber diameters of the embodiment SBCF material may be between 5 and 15 μm.

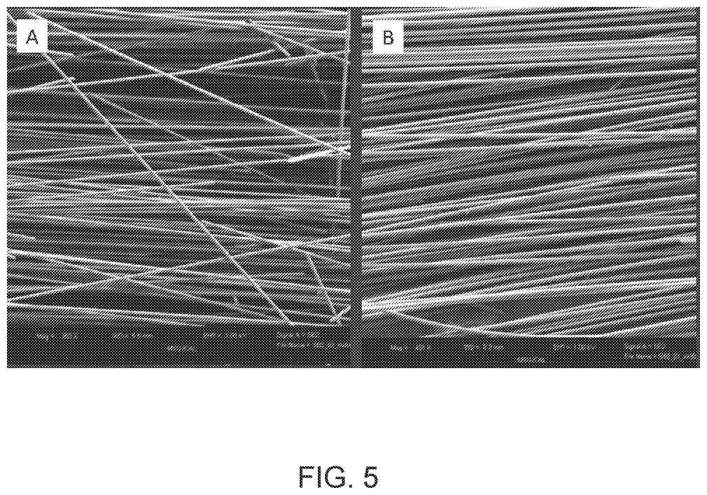

FIG. 5 shows micrographs of SBCF materials, including (A) a comparative example of an SBCF material that was produced using a conventional technique that did not include a carrier film contacting the fiber material during the stretch breaking process, and (B) an embodiment SBCF material that was produced using a carrier film contacting the carbon fiber material during the stretch breaking process, as described above. Micrograph (B) on the right-hand side shows significantly improvement in the alignment of the fibers compared to the comparative example in micrograph (A). Various embodiments include a dry fiber SBCF material in which ≥98% of the fibers are aligned within 2° in each bundle or tow of the SBCF material. As used herein, a “dry fiber” SBCF material is a SBCF material that is free or essentially free of a resin material. As used herein, a “bundle” or “tow” of SBCF material is an untwisted grouping of SBCF material that includes at least 10³ individual carbon fiber filaments. In some embodiments, a tow of SBCF material may include an even number of carbon fiber filaments, such as 3,000 filaments (a “3K tow”), 6,000 filaments (a “6K tow”), 12,000 filaments (a “12K tow”), and so on.

Additional embodiments of the present disclosure include prepreg stretch broken fiber materials. Prepreg stretch broken fiber is a common term for a stretch broken fiber material, such as an SBCF material, that has been pre-impregnated with a resin system. The resin system may include a suitable resin, such as an epoxy, and may also include a suitable curing agent. As a result, the prepreg stretch broken fiber material may be ready to lay into a mold for formation of a part without requiring the addition of a resin material in a separate step.

In some embodiments, a surface of a carrier film 112, 114 that contacts the fiber material 101 during the stretch breaking process may include a resin material, such as an epoxy resin, that may impregnate the stretch broken fibers to provide a prepreg stretch broken fiber material. Alternatively, or in addition, a resin-containing film or sheet, such as a paper sheet including a resin coating, may contact the fibers following the stretch breaking process such that the resin material may impregnate the stretch broken fibers to provide a prepreg stretch broken fiber material.

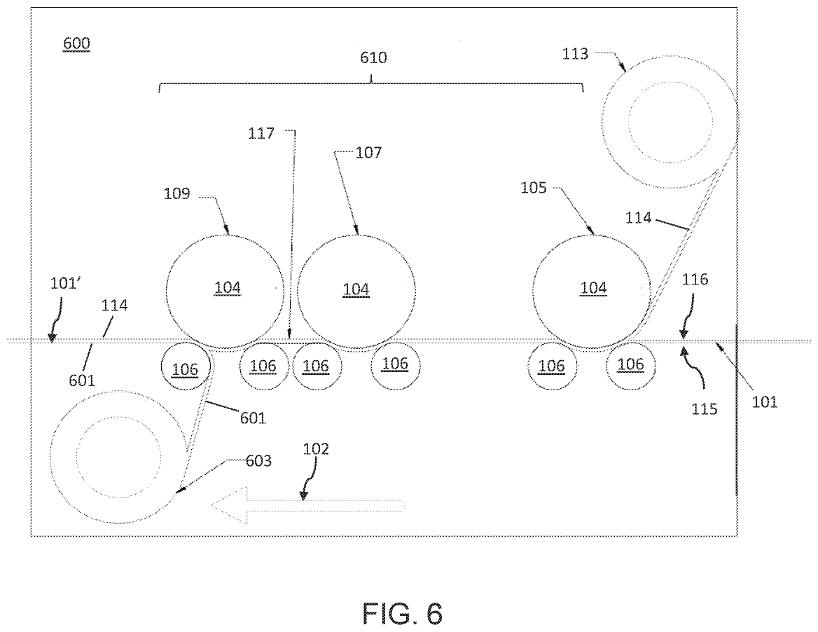

FIG. 6 illustrates an embodiment of a system 600 that may be used to produce prepreg stretch broken fiber material according to various embodiments of the disclosure. The system 600 of FIG. 6 includes a differential roller stretch breaking apparatus 610, and is similar to the system 100 described above with reference to FIG. 1. Thus, repeated discussion of like components is omitted. The system 600 of FIG. 6 differs from the system 100 of FIG. 1 in that a carrier film 114 is fed through the nip stations 105, 107 and 109 and contacts one side 116 of the fiber material 101 during the stretch breaking process, but no carrier film contacts the opposite side 115 of the fiber material 101 during the stretch breaking process. The system 600 also includes a feed apparatus 603 configured to feed a resin-containing sheet 601 into the stretch breaking apparatus 610. In the embodiment of FIG. 6, the feed apparatus 603 may include a spool that may feed the resin-containing sheet 601 into the third nip station 109 of the stretch breaking apparatus 610. In some embodiments, the resin-containing sheet 601 may enter the third nip station 109 downstream of the break zone 117 located between nip stations 107 and 109, and thus the resin-containing sheet 601 may contact the side 115 of the fiber material after is has been stretch broken. The resin material of the resin-containing sheet 601 may impregnate the stretch broken fibers to provide a prepreg stretch broken fiber material 101′. In some embodiments, the resin-containing sheet 601 may be a paper sheet that is coated with an epoxy resin material.

In various embodiments, the surface of the resin-containing sheet 601 that contacts the fiber material 101 may have a tacky or adhesive quality. This may aid the ability of the resin-containing sheet 601 to grip onto the stretch broken fiber material, which may improve the robustness and authority of the stretch breaking system 600. The tacky surface of the resin-containing sheet may also help to immobilize the fibers almost immediately after they are stretch-broken, which may help the stretch broken fibers maintain their alignment. In addition, consistent areal weight of the prepreg fiber material may be assured, as tow spreading and fiber management may be performed while the fiber is still continuous, and thus easier to handle, while a consistent amount of the prepreg resin material may be applied to the fibers after they are stretch broken. This means that industry standard fiber handling techniques may be employed, and a consistent fiber web can be used, as would be the case in any traditional prepreg line. Further, the cost of producing prepreg stretch broken fiber material 101′ may be reduced as compared to other SBCF prepreg materials, and the workflow and machinery required may be greatly simplified.

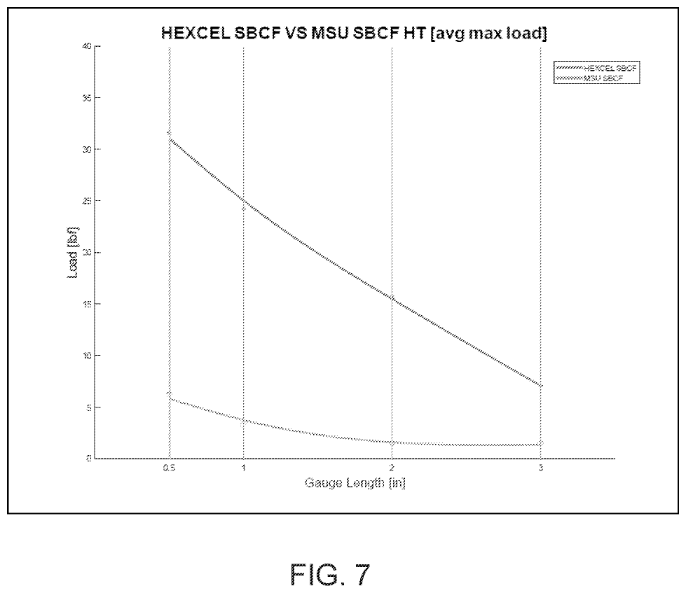

Stretch broken fiber material 101′, such as stretch broken carbon fiber (SBCF) material, that is produced using a carrier film in accordance with various embodiments of the present disclosure may have improved formability compared to conventional stretch broken fiber materials. FIG. 7 is a plot illustrating the formability of an embodiment SBCF material (MSU SBCF) that was produced using a carrier film contacting the carbon fiber material during the stretch breaking process, as described above, in comparison to the formability of a comparative example of an SBCF material (Hexcel SBCF) that was produced using a conventional technique that did not include a carrier film contacting the fiber material during the stretch breaking process. Samples of various lengths were tested by applying tension to the fibers and measurements of the resulting forming forces were made. The tests included tows of ˜12,000 carbon fibers having ˜5.5 μm diameter. The gauge length represents the distance between pinch points at which the fiber tows were supported during the testing. The formability of the respective SBCF tows were tested by applying a load force perpendicular to the direction of the fibers between the pinch points at various gauge lengths. The average maximum load (“avg. max load”) represents the average peak load on the fiber tow before the fibers start elongating (i.e., the strain on the fibers >0.2%). Thus, lower average maximum loads at smaller gauge lengths indicates that the SBCF material is more formable. As shown in FIG. 7, the improved fiber length profile of the embodiment SBCF material (SBCF MSU) provides significantly reduced forming forces as compared to the comparative SBCF material (SBCF Hexcel). In particular, the embodiment SBCF material may be formed into complex shapes much more easily than the comparative SBCF material. This significant improvement in formability may make it much easier to manufacture carbon fiber parts as compared to either traditional continuous-fiber carbon or the conventional SBCF material. In various embodiments, a SBCF material produced using a carrier film contacting the carbon fiber material during the stretch breaking process may be formable using a forming force that is 1 MPa or less.

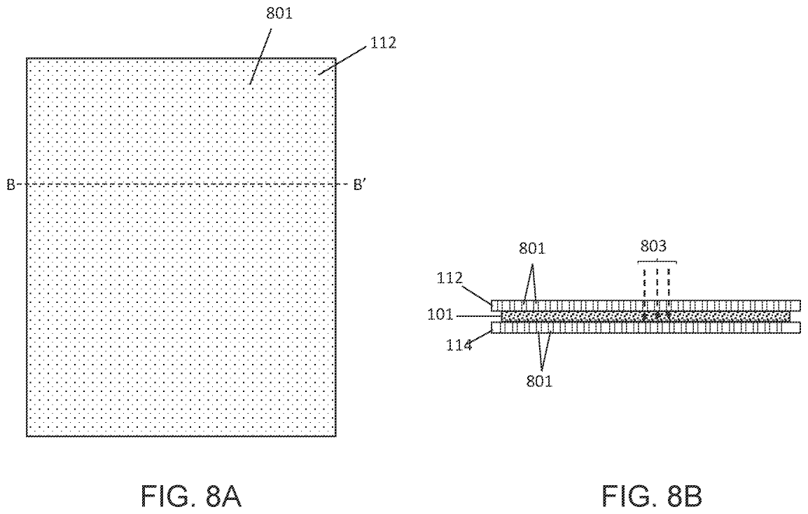

In some embodiments, the carrier film 112, 114 that contacts the fiber material during the stretch breaking process may include perforations through the carrier film 112, 114. FIG. 8A is a top view showing a carrier film 112 including a plurality of perforations 801. FIG. 8B is a cross-section view along line B-B′ in FIG. 8A. As shown in FIG. 8B, the carrier film 112 including perforations 801 contacts an upper surface of a stretch-broken fiber material 101′. In the embodiment of FIG. 8B, a second carrier film 114 including perforations 801 contacts a lower surface of the stretch-broken fiber material 101′.

In various embodiments, a carrier film 112 and/or 114 may be perforated prior to or as part of the stretch breaking process to allow material(s) to reach the fiber material 101 as desired to augment the fiber material 101 and/or to facilitate a process using the fiber material 101. In particular, the carrier film 112 and/or 114 may be perforated so as to not be a barrier to the introduction of the desirable augmentation materials to the fiber prior to or during the stretch breaking process. The arrows 603 in FIG. 8B schematically illustrate an augmentation material introduced to the fiber material 101 through the perforations 601 in carrier film 112.

Sizing is one type of material that may be used to augment processing of stretch broken fiber material 101. Sizing is a thin, homogenous coating applied to the surface of fibers during the manufacturing process to protect the fiber filaments during handling and processing, and also during subsequent compounding and composite processing of the stretch broken fiber material. Sizing materials that are used in a stretch broken fiber material processes may include water soluble polymers called textile sizing agents, chemicals such as modified starch, polyvinyl alcohol (PVA), carboxymethyl cellulose (CMC), and acrylates. Other suitable sizing materials are within the contemplated scope of disclosure. The perforations 601 through the carrier film 112 and/or 114 may be configured to allow sizing solutions to reach the fiber material 101.

The perforations 601 in the carrier film 112 and/or 114 are not limited to allowing the transfer of sizing materials to the carrier film, but may also be used to pass any desirable materials through the carrier film 112 and/or 114 to reach the fiber material 101. Such materials may include, without limitation, solutions, gases, lubricants, steam, hot air or other materials to reach the fiber material 101 as desired to augment the fiber material 101 and/or subsequent processing steps. For example, a sizing agent may be pre-applied to the fiber prior to the stretch breaking process, and a solvent or other softening agent may be transferred through the perforations 601 of the carrier film 112 and/or 114 to reconstitute and activate the pre-applied sizing agent. Suitable solvent/softeners include but are not limited to alcohols, other organic solvents, water or steam.

The perforations 601 may have any desired size (e.g., microholes or macroholes) that will allow the desired augmentation material(s) to pass through the carrier film 112 and/or 114 and reach the fiber material 101. For example, the carrier film 112 and/or 114 may be composed of a microporous material such as a GORETEX® membrane that may allow certain augmentation materials (e.g., steam) to pass through the carrier film 112 and/or 114, while blocking other materials. The perforations 601 in the carrier film 112 and/or 114 may be made by any means desired for optimal introduction of augmentation materials. Such means of perforation may include punching holes, laser burning, drilling, molding or other means of perforation.

In one embodiment, an automated roller including spikes on its outer surface (e.g., a “porcupine roller”) may be used to punch holes into the carrier film 112 and/or 114 as it passes through the stretch breaking process, or prior to the stretch breaking process, such as during the manufacture of the carrier film 112 and/or 114. The pattern and/or size of the perforations 601 formed in the carrier film material may be changed as needed to optimize the stretch broken fiber processing.

Alternatively, a carrier film 112 and/or 114 may be made from a polymeric or other material that has been manufactured with a desirable and optimal porous structure to allow sizing or other augmentation materials to reach or penetrate the fiber material 101. For example, the types of sintered polyethylene technology used in making filters may be used to provide a porous carrier film 112 and/or 114.

A carrier film 112 and/or 114 including perforations 601 may be used to produce a stretch-broken fiber material 101 that is suitable for fabricating (1) a dry material form suitable for weaving or stitching into a fabric (2) a dry material in the form a web or unidirectional tape or (3) a prepreg stretch broken fiber material 101.

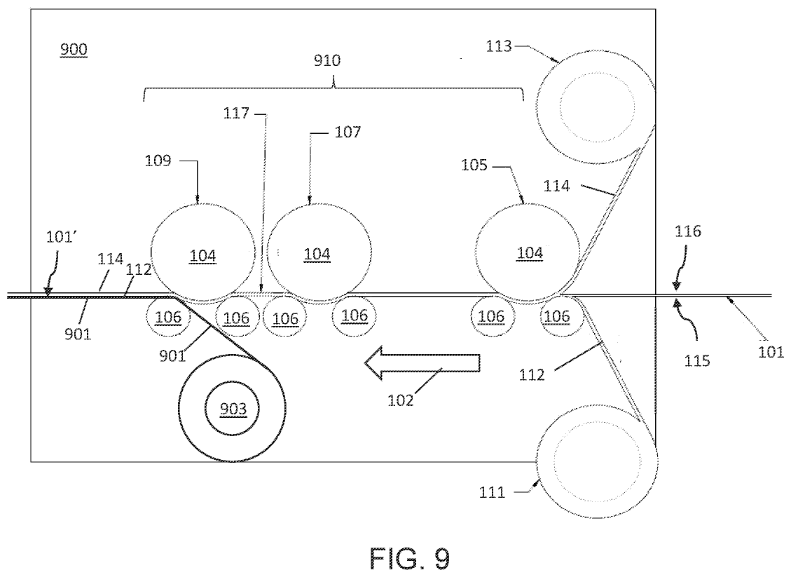

FIG. 9 illustrates another embodiment of a system 900 that may be used to produce stretch broken fiber material according to various embodiments of the disclosure. The system 900 of FIG. 9 includes a differential roller stretch breaking apparatus 910, and is similar to the system 100 described above with reference to FIG. 1. Thus, repeated discussion of like components is omitted. The system 900 of FIG. 6 differs from the system 100 of FIG. 1 in that a stiffening sheet 901 is fed into the stretch breaking apparatus 900 downstream of the break zone 117. The system 900 may include a feed apparatus 903 configured to feed a stiffening sheet 901 into the stretch breaking apparatus 910. In the embodiment of FIG. 9, the feed apparatus 903 may include a spool that may feed the stiffening sheet 901 into the third nip station 109 of the stretch breaking apparatus 910. The stiffening sheet 901 may have a higher stiffness than the first carrier film 112 and the second carrier film 114. In embodiments, the stiffening sheet 901 may contact the first carrier film 112 such that the first carrier film 112 is located between the stiffening sheet 901 and the stretch broken fiber material 101′.

In various embodiments in which carrier films 112 and 114 are located on two sides 115 and 116 of the fiber material 101 during the stretch breaking process, the release of tension on the carrier films 112 and 114 as they exit the stretch breaking apparatus 910 may cause the carrier films 112 and 114 to recoil. This recoil of the carrier films 112 and 114 may induce the formation of a wave pattern in the stretch broken fiber material 101′ between the respective carrier films 112 and 114. This wave pattern in the stretch broken fiber material 101′ may reduce the alignment and organization of the stretch broken fiber material 101′. Accordingly, by providing a stiffening sheet 901 contacting one of the carrier films 112 prior to the carrier films 112 and 114 exiting the stretch breaking apparatus 901, the recoil of the carrier films 112, 114 and the resulting formation of wave patterns in the stretch broken fiber material 101′ may be reduced or eliminated. In some embodiments, the stiffening sheet 901 may be composed of a metal material, such as a spring steel material. Other suitable materials for the stiffening sheet 901 are within the contemplated scope of disclosure. In some embodiments, the stiffening sheet 901 may be a reusable component. The carrier films 112 and 114 and the stretch broken fiber material 101′ may be removed from the stiffening sheet 901, and the stiffening sheet 901 may be recoiled and used again in the stretch breaking system 900.

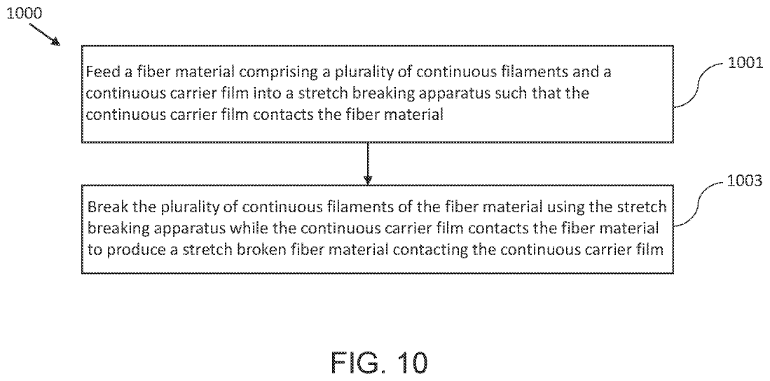

FIG. 10 is a flow diagram illustrating a method 1000 of producing stretch broken fiber material 101′ according to various embodiments of the present disclosure. Referring to FIG. 10, in step 1001 of method 1000, a fiber material 101 including a plurality of filaments and a carrier film 112, 114 may be fed into a stretch breaking apparatus (110, 210, 610, 910) such that the carrier film 112, 114 contacts the fiber material 101. In step 1003 of method 100, at least a portion of the plurality of filaments of the fiber material 101 may be broken using the stretch breaking apparatus (110, 210, 610, 910) while the carrier film 112, 114 contacts the fiber material 101 to produce a stretch broken fiber material 101′ contacting a continuous carrier film 112, 114.

Although the foregoing refers to particular embodiments, it will be understood that the disclosure is not so limited. It will occur to those of ordinary skill in the art that various modifications may be made to the disclosed embodiments and that such modifications are intended to be within the scope of the disclosure. Compatibility is presumed among all embodiments that are not alternatives of one another. The word “comprise” or “include” contemplates all embodiments in which the word “consist essentially of” or the word “consists of” replaces the word “comprise” or “include,” unless explicitly stated otherwise. Where an embodiment using a particular structure and/or configuration is illustrated in the present disclosure, it is understood that the present disclosure may be practiced with any other compatible structures and/or configurations that are functionally equivalent provided that such substitutions are not explicitly forbidden or otherwise known to be impossible to one of ordinary skill in the art. All publications, patents and patent applications referred to herein are incorporated by reference in their entirety to the same extent as if each individual publication, patent or patent application was specifically and individually indicated to be incorporated by reference in its entirety.

1. A method of producing stretch-broken fiber material, comprising:
feeding a fiber material comprising a plurality of continuous filaments and a continuous carrier film into a stretch breaking apparatus such that the continuous carrier film contacts the fiber material; and
breaking at least a portion of the plurality of continuous filaments of the fiber material using the stretch breaking apparatus while the continuous carrier film contacts the fiber material to produce a stretch broken fiber material contacting the continuous carrier film.

2. The method of claim 1, wherein the continuous carrier film comprises a first continuous carrier film that contacts the fiber material on a first side of the fiber material, the method further comprising:
feeding a second continuous carrier film into the stretch breaking apparatus such that the second continuous carrier film contacts the fiber material on a second side of the fiber material that is opposite the first side of the fiber material.

3. The method of claim 1, wherein under a tensile stress the continuous carrier film is able to elongate by at least 6% of a length of the continuous carrier film along the direction of the tensile stress before the continuous carrier film will break.

4. The method of claim 1, wherein the fiber material comprises at least one of a carbon fiber material, a fiberglass material, an organic fiber material, a ceramic fiber material, a glass fiber material, a basalt fiber material, and a graphite fiber material.

5. The method of claim 4, wherein the continuous carrier film comprises at least one of a polymer material, a rubber material, a thermoplastic material, a textile material, a woven material, and a paper-based material.

6. The method of claim 5, wherein the continuous carrier film comprises a resin material over a surface of the continuous carrier film that contacts the fiber material to produce a prepreg stretch broken fiber material contacting the continuous carrier film.

7. The method of claim 2, wherein the second continuous carrier film is fed into the stretch breaking apparatus and contacts the second side of the fiber material prior to breaking at least a portion of the plurality of continuous filaments of the fiber material using the stretch breaking apparatus.

8. The method of claim 2, wherein the second continuous carrier film is fed into the stretch breaking apparatus and contacts the second side of the fiber material after at least a portion of the plurality of continuous filaments of the fiber material are broken using the stretch breaking apparatus.

9. The method of claim 7, wherein the second continuous carrier film comprises a resin-containing sheet comprising a resin material that contacts the second side of the fiber material to produce a prepreg stretch broken fiber material.

10. The method of claim 1, wherein the continuous carrier film comprises a plurality of perforations through the continuous carrier film configured to enable an augmentation agent to pass through the perforations to the fiber material.

11. The method of claim 2, further comprising:
feeding a stiffening film into the stretch breaking apparatus after at least a portion of the plurality of continuous filaments of the fiber material are broken using the stretch breaking apparatus, wherein the stiffening film has a higher stiffness than the first continuous carrier film and the second carrier film, and wherein either the first continuous carrier film or the second carrier film is located between the fiber material and the stiffening film.

12. A system for producing stretch broken fiber material, comprising:
a stretch breaking apparatus configured to break filaments of a fiber material to reduce a mean filament length of the fiber material; and
a feed apparatus configured to feed a continuous carrier sheet into the stretch breaking apparatus such that the continuous carrier sheet contacts the fiber material while the stretch breaking apparatus breaks filaments of the fiber material.

13. The system of claim 12, wherein the stretch breaking apparatus comprises a differential roller stretch breaking apparatus.

14. The system of claim 12, wherein the stretch breaking apparatus comprises a dual platen stretch breaking apparatus.

15. The system of claim 12, wherein the feed apparatus comprises a first feed apparatus configured to feed a first continuous carrier film into the stretch breaking apparatus such that the first continuous carrier film contacts a first side of the fiber material, and the system further comprises a second feed apparatus configured to feed a second continuous carrier film into the stretch breaking apparatus such that the second continuous carrier film contacts a second side of the fiber material that is opposite the first side.

16. The system of claim 12, wherein the second feed apparatus is configured to feed the second continuous carrier film into the stretch breaking apparatus such that the second continuous carrier film contacts the second side of the fiber material prior to the stretch breaking apparatus breaking the filaments of the fiber material.

17. The system of claim 16, wherein the second continuous carrier film comprises a resin-containing sheet comprising a resin material that is fed into the stretch breaking apparatus and contacts the second side of the fiber material after the filaments of the fiber material are broken to provide a prepreg stretch broken fiber material.

18. A stretch-broken carbon fiber material that is formable using a forming force that is 1 MPa or less.

19. The stretch-broken carbon fiber material of claim 1, wherein the stretch-broken carbon fiber material has a mean fiber length of less than 4 cm.

20. A dry stretch-broken carbon fiber product comprising a tow of stretch-broken carbon fibers wherein ≥98% of the fibers of the tow of stretch-broken carbon fibers are aligned within 2°.
